(19) United States
(12) Patent Application Publication
(10) Pub. No.: US 2012/0079566 A1
(43) Pub. Date: Mar. 29, 2012

(54) SECURE OUT-OF-BAND MANAGEMENT OF COMPUTING DEVICES OVER A COMMUNICATIONS NETWORK

(76) Inventors: Roger L. Barranco, Coral Springs, FL (US); Jeffrey Slapp, Coral Springs, FL (US)

(21) Appl. No.: 12/890,622

(22) Filed: Sep. 25, 2010

(51) Int. Cl. H04L 29/06; H04L 9/32; H04L 9/00

(52) U.S. Cl. 726/4; 726/7

(57) ABSTRACT

A method on a computer system for facilitating management of virtual machines in a private data center over a communications network can be provided. The method can include receiving, by a first computer in the private data center, a request via the communications network from a user for access to a subset of a plurality of virtual machines in the private data center. The method can further include executing a first authentication process by proxy between the user and the first computer and executing a second authentication process by proxy between the user and a second computer at the private data center. The method can further include establishing a secure, out-of-band connection between the user and the subset of the plurality of virtual machines in the private data network and restricting access of the user to the subset of the plurality of virtual machines according to permissions associated with the user.

### BACKGROUND OF THE INVENTION

1. Field of the Invention

The present invention relates to the computing and, more specifically, relates to the field of remote management of computing devices over a communications network.

2. Description of the Related Art

As the need for computing power and connectivity continues to grow rapidly for businesses, colocation data centers have been increasing in both popularity and necessity. A colocation data center is a secured brick-and-mortar facility, typically with robust power, environmental controls, and Internet connectivity that is specifically constructed and maintained by an Internet Service Provider, Infrastructure Service Provider, or telecommunications company. Customers of a colocation data center contract for their required physical space, power and Internet connectivity within the facility. In essence, a customer can relocate its critical information technology (IT) infrastructure, Internet connectivity and online services to a colocation data center, thereby eliminating or reducing the need to purchase, build and maintain their own IT infrastructure to perform those services.

One use of a colocation data center involves virtual machines. A virtual machine is a software implementation of a machine (i.e., a physical computer) that executes programs and performs services like a physical machine through the use of a hypervisor. Multiple virtual machines can reside on a physical machine. Virtual machines can have a wide range of capacities with regard to processing power, memory and storage.

Colocation data centers also provide the highly desired environment to support cloud computing. The rise of cloud computing—a method of sharing compute resources—has prompted colocation data centers to enter the business of providing virtual compute, storage and broadband access to these resources for its clients or customers. This model is frequently referred to in the industry as “cloud computing” or Virtual Private Data Center (vPDC). A vPDC is a private and specific allocation of virtual compute, storage and network resources from a large pool of resources within a service provider's vPDC environment, where multiple client or customer vPDCs reside but are kept private or segregated by various processes. As a client's compute and related network resource demands increase, a cloud or vPDC provider can respond promptly by providing its customer with the necessary compute and network resources to accommodate the additional requirements.

Customers of a vPDC choose to “lease” compute and storage resources, also known as virtual machines, rather than purchase the physical infrastructure. Typically in this environment, customers must still, however, install, maintain, update and administer their own software and applications installed on the virtual machines. Thus, the customer and/or its administrator must regularly log onto each virtual machine to perform regular maintenance. IT industry professionals, however, have expressed security concerns about placing their data and applications in a cloud or vPDC environment.

One common concern with remotely administering physical machines or virtual machines in a cloud or vPDC environment is security, especially in cases involving certain market segments or industries with specific security and compliance requirements. There are serious security concerns about web-based administrator access to both physical and virtual machines. Unauthorized intrusions via the Internet—for motives including vandalism, credit card fraud, identity theft, piracy, or other types of illegal activity—are rampant. The current approaches to securing web-based administrator access to both physical and virtual machines do not adequately address the security concerns of the industry.

What is needed is a system and method for addressing the problems with the prior art, and more particularly for a more efficient method and system for providing secure management of virtual machines in a cloud or vPDC environment over a communications network.

### BRIEF SUMMARY OF THE INVENTION

Embodiments of the present invention address deficiencies of the art in respect to computing and provide a novel and non-obvious method for management of virtual machines over a communications network. In an embodiment of the invention, a method on a computer system for facilitating management of virtual machines in a cloud or vPDC environment over a communications network can be provided. The method can include receiving, by a first computer in the vPDC, a request via the communications network from a user for access to a subset of a plurality of virtual machines in the vPDC. The method can further include executing a proxied first authentication process between the user and the first computer and executing a proxied second authentication process between the user and a second computer at the vPDC. The method can further include establishing a secure, out-of-band connection between the user and the subset of the plurality of virtual machines in the vPDC network and restricting access of the user to the subset of the plurality of virtual machines according to permissions associated with the user.

In another embodiment of the invention, a computer system for facilitating management of virtual machines in a vPDC over a communications network can be provided. The computer system can include a first computer in the vPDC, the first computer configured for receiving a request via the communications network from a user for access to a subset of the plurality of virtual machines in the vPDC and executing a proxied first authentication process with the user. The computer system can further include a second computer in the vPDC, the second computer configured for executing a proxied second authentication process with the user. The computer system can further include a server in the vPDC, the server configured for establishing a secure, out-of-band connection between the user and the subset of the plurality of virtual machines in the vPDC network and restricting access of the user to the subset of the plurality of virtual machines according to permissions associated with the user.

In another embodiment of the invention, a computer program product comprising a computer usable medium embodying computer usable program code for facilitating management of virtual machines in a private data center over a communications network can be provided. The computer program product includes computer usable program code on a first computer in the private data center for receiving a request via the communications network from a user for access to a plurality of virtual machines in the private data center and executing a proxied first authentication process between the user and the first computer. The computer program product further includes computer usable program code on a second computer in the private data center for executing a proxied second authentication process between the user and the second computer. The computer program product further includes computer usable program code on a server for establishing a secure, out-of-band connection between the user and the plurality of virtual machines in the private data network and restricting access of the user to the plurality of virtual machines according to permissions associated with the user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for managing computing devices over a communications network, in accordance with one embodiment of the present invention.

FIG. 2 is a block diagram providing more detail of the vPDC of FIG. 1 employing one embodiment of the present invention.

FIG. 3 is a flow chart describing the control flow of the overall process managing computing devices over a communications network, in accordance with one embodiment of the present invention.

### DETAILED DESCRIPTION OF THE INVENTION

The present invention improves upon the problems with the prior art by providing a more effective method and system for securely and remotely managing virtual machines in a cloud computing or vPDC environment over a communications network such as the Internet. The present invention solves the problems of the prior art related to security by providing a novel two-step authentication method for authenticating an administrator attempting to gain secure web-based access to virtual machines in a vPDC. The aforementioned method uses two independent and technologically disparate authentication methodologies executed by two separate computers, thereby increasing the security of the underlying system. Additionally, the access to the authentication processes is proxied. The present invention further improves upon the prior art related to security by restricting the administrator's web-based access to the virtual machines according to a predefined permissions profile associated with the administrator's identity.

Additionally, the present invention improves upon the prior art by providing a scalable and easy-to-use system for remotely managing virtual machines in a cloud computing or vPDC environment, even when those virtual machines, or their host computers, are down or malfunctioning. More specifically, the present invention allows for secure, out-of-band management of the virtual machines in the vPDC, thereby allowing customers and administrators to perform health and safety procedures on the virtual machines when they are experiencing problems. In this way, the present invention improves over the prior art by providing a direct and expedient method for administrators, who are remotely located, to remotely manage virtual machines in a vPDC, while still providing a high level of security during the process.

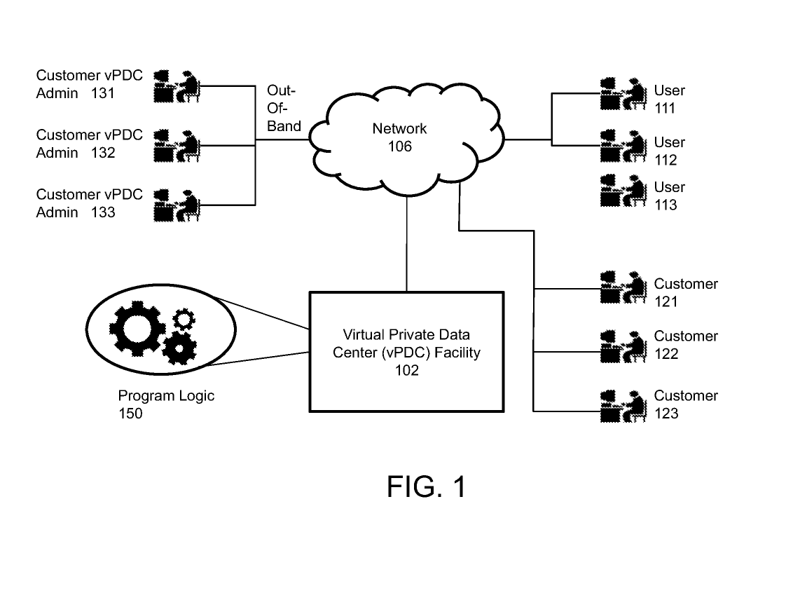

Referring now to the drawing figures in which like reference designators refer to like elements, there is shown in FIG. 1 an illustration of a block diagram showing the network architecture of a system and method in accordance with the principles of the present invention. FIG. 1 shows an embodiment of the present invention wherein individuals 111-113, 121-123 and 131-133, comprising an individual and a computer, interact with vPDC facility 102 over a network 106, which can be a packet switched network such as the Internet or the World Wide Web. The computers of individuals 111-113, 121-123 and 131-133 can be desktops, laptops, handheld computers, smart phones, tablet computers or the like.

As explained above, vPDC facility 102 is a collection of Internet-accessible computers and bandwidth located in one facility. Customers 121-123 represent customers of the vPDC facility 102, thereby accessing virtual compute, bandwidth and/or other resources from vPDC facility 102. Administrators 131-133 are individuals employed by any customer 121-123, charged with administering the machines leased by a customer (i.e., the customer's specific vPDC), including the general duties of overseeing the security, integrity, health and overall safety of aforesaid machines. Administrators 131-133 enjoy out-of-band access to vPDC facility 102. Users 111-113 comprise a plurality of individuals that are serviced by the business of a customer 121-123. In the example where customer 121 is an online retailer, users 111-113 are purchasers of the goods of customer 121. It should be noted that although FIG. 1 shows only three administrators 131-133, three users 111-113 and three customers 121-123, the system of the present invention supports any number of administrators, users and customers connected via network 106.

vPDC facility 102 includes program logic 150 comprising computer source code, object code, executable code, scripting language code and/or interpreted language code that is compiled to produce computer instructions that perform various functions of the present invention. Program logic 150 may reside solely on one or more computers of the virtual private data center facility 102, or may be distributed between one or more computers of the virtual private data center facility 102. In one alternative of the present invention, the program logic 150 is a secure clientless connection executed on client computers 131-133 and a server application that resides in vPDC facility 102.

Note that although vPDC facility 102 is shown as a single and independent entity, in one embodiment of the present invention, the functions of vPDC 102, and program logic 150 by extension, may be integrated with the functions of another remote entity. Further, vPDC facility 102 and its functionality encompassed by program logic 150, according to one embodiment of the present invention, can be realized in a centralized fashion in one computer system or in a distributed fashion where different elements are spread across several interconnected computer systems.

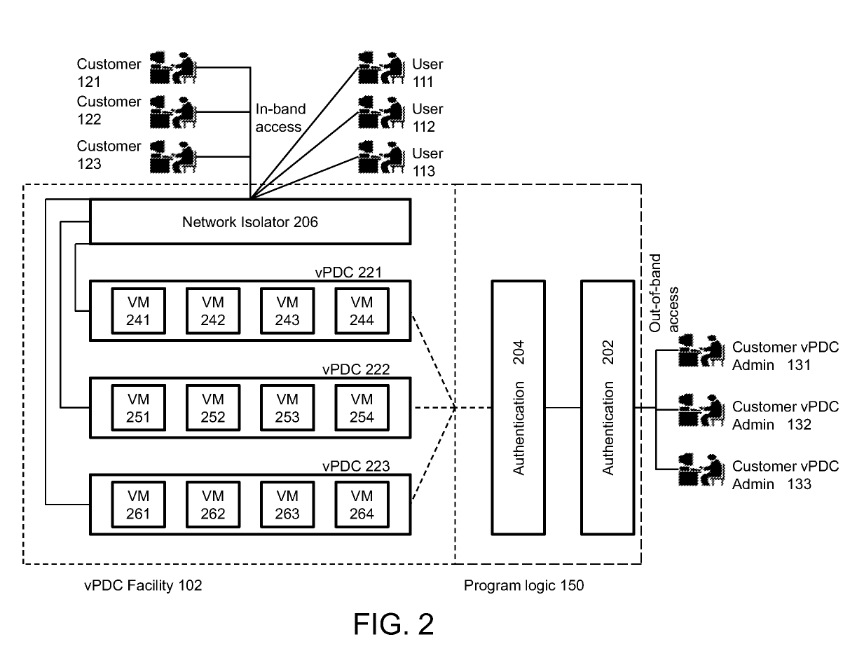

FIG. 2 is a block diagram providing more detail of the vPDC facility 102 of FIG. 1 employing one embodiment of the present invention. FIG. 2 shows groups of virtual machines that comprise the virtual private data center (vPDC) available to a particular customer. A customer of the vPDC facility 102, such as customer 121, may lease certain ones of the virtual machines in the vPDC facility 102. In this example, customer 121 leases and therefore operates and/or administrates, in-band, virtual machines 241-244, which together comprise the vPDC 221, or the virtual private data center that corresponds to the customer 121. Likewise, vPDC 222, comprising virtual machines 251-254, corresponds to customer 122, and vPDC 223, comprising virtual machines 261-264, corresponds to customer 123.

FIG. 2 shows that in-band access to the virtual machines in the vPDC facility 102 is provided to users 111-113. In-band access is the use of regular data channels (usually through Internet Protocol (IP)) to access computing devices. A significant limitation of in-band access is its vulnerability to inherent problems experienced by the very computing devices that are being accessed. To manage computing devices remotely, administrators 131-133 require network access to the computing devices when problems occur. However, the same problems that cause the network to go down also result in the loss of access to those computing devices. Out-of-band access addresses this limitation by employing a channel that is isolated from the in-band access channel.

FIG. 2 shows that out-of-band access to the virtual machines in the vPDC facility 102 is provided to administrators 131-133. Out-of-band management access to the virtual machines of the vPDC facility 102 is provided even in the event of primary network subsystem (hardware and/or software) failure. In one embodiment of the present invention, out-of-band management access is provided via a console server or a remote access system, which has its own processor, memory, storage, network connection, and access to the vPDC facility 102. In FIG. 2, for example, customer vPDC administrator 131 is provided with out-of-band management access to its virtual machines' 241-244 base functions via a console server corresponding to vPDC 221.

FIG. 2 further shows two independent and technologically disparate authentication methodologies executed by two separate computers, 202 and 204. Each machine 202, 204 performs its own independent authentication process each time an administrator 131-133 attempts to engage in out-of-band management access to the virtual machines of the vPDC facility 102. The authentication processes of machines 202, 204 may be encompassed by program logic 150.

In one embodiment of the present invention, the first machine or computer 202 engages in an authentication process that includes sending a request for credentials to a customer vPDC administrator, such as administrator 131, receiving and verifying credentials provided by the administrator 131, reading an IP address of the customer's computer and opening one or more specified TCP ports on the computer 202 for sole use by packets received from the IP address of the computer of administrator 131. In this manner, security of the connection between the administrator 131 and the vPDC facility 102 is ensured via the use of credentials and the access limitations placed on the TCP ports of computer 202 used to communicate with administrator 131. In one embodiment of the present invention, the connection between administrator 131 and computer 202 is an encrypted connection, such as a secure socket layer (SSL) connection. In another embodiment of the present invention, the connection from administrator 131 is proxied to computer 202 such that administrator 131 does not have a direct connection to computer 202. A proxy system uses a computer system or an application program that acts as an intermediary for requests from administrator 131 seeking resources or processes from computer 202.

Once authentication has been completed by the authentication process of computer 202, the authentication process of computer 204 commences. In another embodiment of the present invention, the second machine or computer 204 engages in an authentication process that includes sending a request for credentials to the administrator 131, receiving and verifying credentials provided by the administrator 131, and verifying a presence of a profile associated with the administrator 131 based on the credentials provided by the administrator 131. In this manner, security of the connection between the administrator 131 and the vPDC facility 102 is ensured via the use of credentials and the verification of a pre-existing user profile associated with administrator 131, wherein the profile proves the existence of an active client. In another embodiment of the present invention, the connection between administrator 131 and computer 204 is an encrypted connection, and the connection from administrator 131 is proxied to computer 204.

In yet another embodiment of the present invention, the authentication process of administrator 131 additionally reads the profile associated with the administrator 131, wherein the profile includes permissions of the administrator 131 in relation to the vPDC 221—i.e., virtual machines 241-244—that are leased and administrated in-band by customer 121.

FIG. 2 further shows network isolator 206, which acts as a gatekeeper of the vPDC 102 with respect to users 111-113 engaged in an in-band connection with the virtual machines of vPDC 102. The function of network isolator 206 is to further segregate routed network space and provide bandwidth management capabilities down to the level of the individual vPDC according to the amount of bandwidth each vPDC requires.

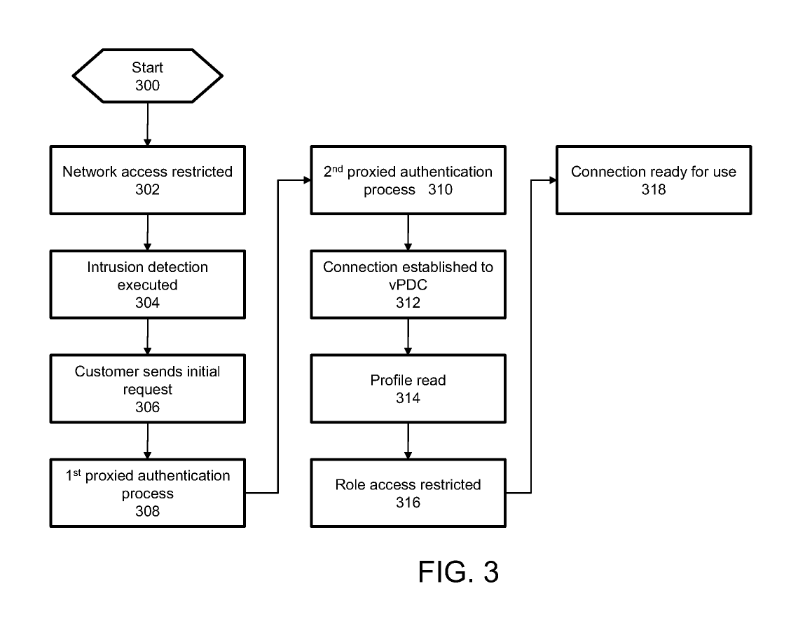

FIG. 3 is a flow chart describing the control flow of the overall process managing computing devices over a communications network, in accordance with one embodiment of the present invention. The flow chart of FIG. 3 describes the process undertaken when an administrator 131 remotely accesses certain virtual machines in the vPDC facility 102, using the system of the present invention. The flow chart of FIG. 3 is described in association with FIG. 2.

The following control flow presupposes, by way of example, that administrator 131, which is a customer of vPDC facility 102, seeks to remotely manage certain leased virtual machines 241-244 in the vPDC 221 that corresponds to customer 121. In a first step 302, program logic 150 executes an intrusion detection routine. This routine encompasses the act of monitoring IP packets and comparing the IP packets that were monitored against a set of signatures so as to identify intrusion activity, and respond accordingly. The intrusion detection routine may sever or restrict a connection that is deemed an intrusion. In a next step 304, program logic 150 provides network access to the administrator 131 by opening only required ports to the authenticated administrator 131, as described above.

In a step 306, administrator 131 sends to computer 202 a request over network 106 for access to virtual machines 241-244 in vPDC 221. Administrator 131 will, for example, send an HTTPS request to computer 202. In step 308 the first computer 202 executes the first proxied authentication process as described in greater detail above. Assuming the administrator 131 is fully authenticated in the first authentication process, the control flows to the next proxied authentication process.

In step 310, the second computer 204 executes the second proxied authentication process as described in greater detail above. Assuming the administrator 131 is fully authenticated in the second authentication process, in step 312 a secure out-of-band connection is established between the administrator 131 and vPDC facility 102. In step 314, the authentication process of computer 204 reads the profile associated with the administrator 131, and in particular, the permissions of the administrator 131 in relation to the virtual machines 241-244 that are leased and administrated by customer 121. In step 316, program logic 150 restricts access of the administrator 131 to the virtual machines 241-244 according to the permissions associated with the administrator 131. In step 318 the secure out-of-band connection between the administrator 131 and the vPDC facility 102 (specifically, vPDC 221) is fully established and ready for use.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data and instructions from the computer readable medium.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a computer system for facilitating management of virtual machines in a private data center over a communications network, comprising:
receiving, by a first computer in the private data center, a request via the communications network from a user for access to a subset of a plurality of virtual machines in the private data center;
executing a first authentication process by proxy between the user and the first computer;
executing a second authentication process by proxy between the user and a second computer at the private data center;
establishing a secure, out-of-band connection between the user and the subset of the plurality of virtual machines in the private data network; and
restricting access of the user to the subset of the plurality of virtual machines according to permissions associated with the user.

2. The method of claim 1, wherein the step of executing a first authentication process further comprises:
sending, by the first computer, a request for credentials from the user;
receiving and verifying, by the first computer, credentials provided by the user;
reading, by the first computer, an IP address of the user's computer; and
opening one or more specified TCP ports on the first computer for sole use by packets received from the IP address of the user's computer.

3. The method of claim 2, wherein the step of executing a second authentication process further comprises:
sending, by the second computer, a request for credentials from the user;
receiving and verifying, by the second computer, credentials provided by the user;
verifying, by the second computer, a presence of a profile associated with the user based on the credentials provided by the user; and
accessing, by the second computer, the profile associated with the user, wherein the profile includes permissions of the user in relation to the subset of the plurality of virtual machines in the private data center.

4. The method of claim 3, further comprising:
monitoring IP packets exchanged between the user's computer and the subset of the plurality of virtual machines in the private data center; and
comparing the IP packets that were monitored against a set of signatures identifying intrusion activity so as to identify intrusion activity in the connection between the user's computer and the subset of the plurality of virtual machines in the private data center.

5. The method of claim 4, further comprising:
restricting each of the plurality of virtual machines from providing access to data and processing to other virtual machines, so as to further segregate routed network space and provide bandwidth management capabilities for each virtual machine of the plurality of virtual machines from others.

6. The method of claim 5, wherein the step of restricting each of the plurality of virtual machines further comprises:
providing bandwidth management capabilities for each virtual machine of the plurality of virtual machines according to an amount of bandwidth required by the plurality of virtual machines.

7. A computer system for facilitating management of virtual machines in a private data center over a communications network, comprising:
a first computer in the private data center, the first computer configured for receiving a request via the communications network from a user for access to a subset of the plurality of virtual machines in the private data center and executing a first authentication process by proxy with the user;
a second computer in the private data center, the second computer configured for executing a second authentication process by proxy with the user; and
a server in the private data center, the server configured for establishing a secure, out-of-band connection between the user and the subset of the plurality of virtual machines in the private data network and restricting access of the user to the subset of the plurality of virtual machines according to permissions associated with the user.

8. The computer system of claim 7, wherein the step of executing, by the first computer, a first authentication process further comprises:
sending a request for credentials from the user;
receiving and verifying credentials provided by the user;
reading an IP address of the user's computer; and
opening one or more specified TCP ports on the first computer for sole use by packets received from the IP address of the user's computer.

9. The computer system of claim 8, wherein the step of executing, by the second computer, a second authentication process further comprises:
sending a request for credentials from the user;
receiving and verifying credentials provided by the user;
verifying a presence of a profile associated with the user based on the credentials provided by the user; and
accessing the profile associated with the user, wherein the profile includes permissions of the user in relation to the subset of the plurality of virtual machines in the private data center.

10. The computer system of claim 9, wherein the server is further configured for:
monitoring IP packets exchanged between the user's computer and the subset of the plurality of virtual machines in the private data center; and
comparing the IP packets that were monitored against a set of signatures identifying intrusion activity so as to identify intrusion activity in the connection between the user's computer and the subset of the plurality of virtual machines in the private data center.

11. The computer system of claim 10, further comprising a third computer configured for:
restricting each of the plurality of virtual machines from providing access to data and processing to other virtual machines, so as to further segregate routed network space and provide bandwidth management capabilities for each virtual machine of the plurality of virtual machines from others.

12. The computer system of claim 11, wherein the third computer is further configured for:
providing bandwidth management capabilities for each virtual machine of the plurality of virtual machines according to an amount of bandwidth required by the plurality of virtual machines.

13. A computer program product comprising a computer usable medium embodying computer usable program code for facilitating management of virtual machines in a private data center over a communications network, the computer program product comprising:
computer usable program code on a first computer in the private data center for receiving a request via the communications network from a user for access to a plurality of virtual machines in the private data center and executing a first authentication process by proxy between the user and the first computer;
computer usable program code on a second computer in the private data center for executing a second authentication process by proxy between the user and the second computer; and
computer usable program code on a server for establishing a secure, out-of-band connection between the user and the plurality of virtual machines in the private data network and restricting access of the user to the plurality of virtual machines according to permissions associated with the user.

14. The computer program product of claim 13, wherein the computer usable program code on the first computer further comprises:
computer usable program code for sending a request for credentials from the user, receiving and verifying credentials provided by the user, reading an IP address of the user's computer and opening one or more specified TCP ports on the first computer for sole use by packets received from the IP address of the user's computer.

15. The computer program product of claim 14, wherein the computer usable program code on the second computer further comprises:
computer usable program code for sending a request for credentials from the user, receiving and verifying credentials provided by the user, verifying a presence of a profile associated with the user based on the credentials provided by the user and accessing the profile associated with the user, wherein the profile includes permissions of the user in relation to the plurality of virtual machines in the private data center.

16. The computer program product of claim 15, wherein the computer usable program code on the server further comprises:
computer usable program code for monitoring IP packets exchanged between the user's computer and the plurality of virtual machines in the private data center and comparing the IP packets that were monitored against a set of signatures identifying intrusion activity so as to identify intrusion activity in the connection between the user's computer and the plurality of virtual machines in the private data center.

17. The computer program product of claim 16, further comprising:
computer usable program code on a third computer for restricting each of the plurality of virtual machines from providing access to data and processing to other virtual machines, so as to further segregate routed network space and provide bandwidth management capabilities for each virtual machine of the plurality of virtual machines from others.

18. The computer program product of claim 17, wherein the computer usable program code on the third computer is further configured for providing bandwidth management capabilities for each virtual machine of the plurality of virtual machines according to an amount of bandwidth required by the plurality of virtual machines.
